(19) United States
(12) Patent Application Publication
(10) Pub. No.: US 2026/0340304 A1
(43) Pub. Date: Oct. 29, 2026

(54) DIVERSE SAMPLE SYNTHESIS FOR ACCURATE CLASSIFICATION MODELS

(71) Applicant: Optum Services (Ireland) Limited, Dublin (IE)

(72) Inventor: Colum Foley, Dublin (IE)

(21) Appl. No.: 19/188,800

(22) Filed: Apr. 24, 2025

(51) Int. Cl. G06F 40/40; G06F 18/2415

(52) U.S. Cl. CPC G06F 40/40; G06F 18/2415

(57) ABSTRACT

The disclosed techniques can improved classification accuracy for portions of records (e.g., sections of medical records). To this end, the disclosed techniques generate a diverse set of synthetic samples that are used to build (generated or update) a classification model. In some embodiments, the techniques determine which label(s) the classification model, and possibly other classification models, is/are to use for classification of record portions. For a given label, the techniques generate subsets of a set of synthetic samples by iteratively prompting a language model, with the prompt instructing the language model to generate one or more samples that are diverse from at least some of the previously generated samples (e.g., the most recent N samples). Real-world samples may be used as seed samples for the process to help ensure the synthetic samples are generally more reflective of real-world samples, despite being diverse from the specifics of those real-world samples.

### TECHNICAL FIELD

The present disclosure generally relates to classification models, and more particularly, to techniques for generating and using classification models having increased accuracy.

### BACKGROUND

Classification models are used in various fields and use cases to automatically label or classify text. However, the accuracy of these models (and/or other model performance metrics such as precision, recall, etc.) can be poor, such as when attempting to classify text that is very different in nature from the text samples that the model was trained or otherwise built upon. Poor or even moderate levels of classification/labeling performance may be unacceptable in important or sensitive use cases such as healthcare applications, where low accuracy can lead to substantial inefficiencies, confusion, costs, and/or other negative outcomes.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates the same element or a similar element.

FIG. 1 depicts an example computing environment in which various embodiments of the present disclosure can be implemented.

FIG. 2 depicts an example process for determining candidate labels from historical reviews, which may be implemented by the computing system of FIG. 1.

FIG. 3 depicts an example process for generating synthetic samples for a set of labels, which may be implemented by the computing system of FIG. 1.

FIG. 4 depicts an example process for generating synthetic samples for a label using real-world samples as seed samples, which may be implemented by the computing system of FIG. 1.

FIG. 5 depicts an example process for generating or updating one or more classification models, which may be implemented by the computing system of FIG. 1.

FIG. 6 depicts an example process for using a classification model to label portions of a record, which may be implemented by the computing system of FIG. 1.

FIG. 7 depicts a flow diagram of an example computer-implemented method for facilitating accurate labeling of record portions.

### DETAILED DESCRIPTION

As explained above in the Background, the performance of conventional text classification/labeling models may be unacceptable for certain use cases. In the healthcare field, for example, it can be important to accurately label portions/sections of medical records (e.g., records associated with a health insurance claim) to facilitate efficient further review of those sections (e.g., to facilitate the quick identification of relevant sections by human reviewers). Poor classification/labeling performance can result from various factors, including an insufficient number of labeled samples that were used to build the classification model. Strong model performance is generally dependent not only on the number of samples used to build the classification model, but also the variety/diversity of those samples. For example, insufficiently diverse sample sets can result in model bias, inability to recognize patterns in data, overfitting, and/or lack of robustness. This can be particularly problematic in scenarios where it is costly or infeasible to obtain a large, diverse collection of real-world samples that are properly/accurately labeled.

Techniques (systems, methods, processes, etc.) of the present disclosure can advantageously avoid or otherwise mitigate/reduce such deficiencies in the sample sets used to build (e.g., generate or update) classification models, and thereby improve the classification/labeling performance of the resulting models, by automatically synthesizing labeled samples that are both (1) representative of real-world samples (i.e., provide reliable “ground truth” data for building the model) and (2) diverse. In particular, for a given classification/label, the disclosed techniques can iteratively prompt a language model (e.g., a large language model (LLM), such as a transformer-based LLM) to generate a set of synthetic samples for building (generating or updating) a classification model. The iterative prompting includes instructing the language model to generate, in a given iteration, one or more samples, with at least one of the prompts (e.g., all prompts after an initial prompt) further instructing the language model to generate sample(s) that are diverse from at least a portion of the earlier-generated synthetic samples (i.e., diverse from synthetic samples that the language model generated during one or more earlier iterations). In some embodiments, a high level of diversity is maintained despite context window size limits, e.g., by incorporating only the most recent N synthetic samples in the prompt of a current iteration, where Nis any suitable number that the context window size can support.

In some embodiments, before generating sets of synthetic samples for one or more labels, the disclosed techniques can further automate the process by determining which labels the classification model should be using as candidates when classifying new records. For example, the disclosed techniques may analyze historical reviews of records that were generated by individuals (e.g., notes in which subject matter experts manually labeled sections of records), and determine the set of labels based on which labels most commonly appear in the historical reviews. The disclosed techniques may then repeat the iterative prompting technique discussed above for each of one, some, or all labels in the resulting set of labels, to generate the set(s) of synthetic samples upon which the classification model will be built.

Moreover, in some embodiments, the disclosed techniques include at least one real-world sample in at least one prompt (e.g., the initial prompt) of the iterative process, to act as a “seed” sample. Advantageously, this can help ensure that the initial synthetic sample(s) (and, by extension, the sample(s) generated in later iteration(s)) are generally more representative of real-world samples (e.g., less likely to reflect hallucinations by the language model, etc.), which in turn further improves performance of the resulting classification model. For a given label, for example, each sample of a set of real-world samples may be used to seed a different iterative prompting process of the sort described above.

Of course, it should be appreciated that the advantages and technical improvements described above and elsewhere herein are not the only advantages and/or technical improvements that may be realized from the techniques described herein. Other advantages and/or technical improvements to the functioning of a computer itself or other technologies or technical fields may be apparent to one of ordinary skill in the art.

While examples discussed or shown herein at times refer to the healthcare field (e.g., a use case in which portions/sections of medical records are automatically labeled), it is understood that the disclosed techniques and embodiments can instead or additionally be applied to other fields and/or use cases that may benefit from automated text classification/labeling, such as financial fields, legal fields, and so on.

### Example Computing Environment

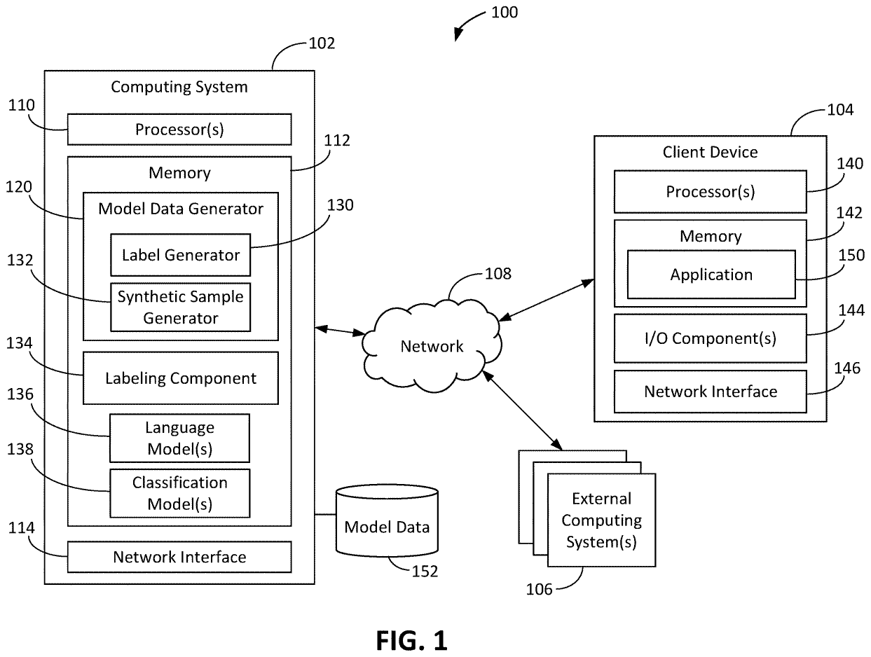

FIG. 1 depicts an example computing environment 100 in which various embodiments of the present disclosure may be implemented. Generally, the example computing environment 100 includes a computing system 102, a client device 104, and external computing systems 106, some or all of which are communicatively coupled to each other via a network 108 as shown in FIG. 1.

Generally, the client device 104 is a computing device that may be associated with a user who reviews one or more types of text documents (or messages, etc.) in the regular course of operations within a particular field or business. For example, the user may be an individual who is employed by a health insurance payor and reviews medical records associated with claims to assess claim accuracy. The classification/labeling techniques disclosed herein may be used to allow such a user to quickly and accurately locate particular medical record sections of interest (e.g., principal diagnosis section, claim audit status section, etc.), for instance. As another example, the user may be an individual who is employed by an auditing services provider and reviews financial disclosure statements to identify “red flag” situations.

The computing system 102 may be associated with an organization that provides an internally and/or externally facing service for classifying/labeling records or record portions. As used herein, the term “record” may refer to electronic text of any type (file, document, message, etc.), and may include a single file, document, etc., or multiple files, documents, etc. For example, a “record portion” may be a portion/subset of a single file, or may be a single file among a set of files, etc. In some embodiments, the computing system 102 is associated with an entity that exclusively provides such a service. In other embodiments, the computing system 102 is associated with an entity such as a health insurance payor, or any other suitable entity. The computing system 102 and client device 104 may be associated with the same entity or different entities. The computing system 102 may include a single server, or multiple servers that are co-located and/or remotely distributed, for example. In some embodiments, the computing system 102 provides services via a cloud platform (e.g., Amazon Web Services (AWS)®, Microsoft Azure®, or Google Cloud®).

The computing system 102 includes one or more processors 110, memory 112, and a network interface 114. The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute processor-executable code/instructions stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory, computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data).

In the example computing environment 100, the memory 112 stores the processor-executable instructions of a model data generator 120, which includes a label generator 130 and a synthetic sample generator 132, as well as a labeling component 134, one or more language models 136, and one or more classification models 138. These components are discussed in further detail below, according to various embodiments.

In some embodiments, the model data generator 120 includes more, fewer, and/or different components, and/or the memory 112 may store more, fewer, and/or different components, than what is depicted in FIG. 1. In some embodiments, for example, neither memory 112 nor any other portion of the computing environment 100 includes label generator 130, and/or computing environment 100 does not include external computing system(s) 106, etc. Additionally or alternatively, in some embodiments, some or all of the components that FIG. 1 shows as being stored in memory 112 are instead stored remotely, and are remotely accessed/used by the computing system 102. For example, the computing system 102 may remotely access the functionality of the model data generator 120 (or just the functionality of the synthetic sample generator 132, etc.) and/or the labeling component 134 via a cloud service provided by another entity and computing system. As another example, the memory 112 may store model data generator 120 and/or labeling component 134 locally, but model data generator 120 and/or labeling component 134 may remotely access (e.g., via one or more application programming interfaces (APIs), or websites, etc.) language model(s) 136 and/or classification model(s) 138, respectively.

The network interface 114 includes one or more hardware and/or software components that are generally configured to enable the computing system 102 to communicate, via the network 108, with other components and/or devices of the computing environment 100, such as the client device 104 and external computing system(s) 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and client device 104, and one or more separate networks for communications between computing system 102 and external computing system(s) 106, etc.).

The client device 104 may be a desktop computer, a laptop computer, a tablet device, a mobile device, a wearable device (e.g., augmented or virtual reality glasses/headsets), or any other suitable computing device. The client device 104 includes one or more processors 140, memory 142, one or more input/output (I/O) components 144, and a network interface 146. The processor(s) 140 may include any suitable number of processors and/or processor types. In some examples, the processor(s) 140 include one or more CPUs, one or more GPUs, one or more TPUs, one or more FPGAs, one or more ASICs, and/or the like. Generally, the processor(s) 140 comprise hardware configured to execute instructions (e.g., processor-executable code/instructions) stored in the memory 142. The memory 142 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 142 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 142 stores the processor-executable instructions of an application 150, which may be, for example, a web browser application or a dedicated application (e.g., a claims review application supported by an entity associated with computing system 102).

The I/O component(s) 144 include hardware and/or software that generally enables a user of client device 104 (i.e., a reviewer) to interact with the client device 104, e.g., for purposes of reviewing records having sections that were labeled by labeling component 134 using classification model(s) 138. The I/O component(s) 144 may include one or more input components that enable a user of client device 104 to enter inputs to the client device 104 (e.g., a keyboard, a microphone, etc.), one or more output components that enable the user to perceive outputs generated by the client device 104 (e.g., a monitor/display, a speaker, a haptic feedback component, etc.), and/or one or more integrated I/O components (e.g., a touchscreen). The I/O component(s) 144 may use any suitable technology or technologies, such as LED, OLED, or LCD display technology, for example. While FIG. 1 shows client device 104 as a single component communicating (via network 108) with the computing system 102, in some implementations the components of client device 104 shown in FIG. 1 are instead divided among two or more client/user-side devices. As just one example, a pair of smart glasses may include one portion of the processor(s) 140, at least a portion of the memory 142, and a display of the I/O component(s) 144, while a smartphone may include another portion of the processor(s) 140, another portion of the memory 142, a touchscreen of the I/O component(s) 144, and the network interface 146. The smart glasses may then communicate as needed with the smartphone (e.g., via Bluetooth®) to enable the operations described herein.

The network interface 146 includes one or more hardware and/or software components that are generally configured to enable the client device 104 to communicate, via the network 108, with other components and/or devices of the computing environment 100, such as the client device 104. To this end, the network interface 146 includes hardware and/or software that operates in accordance with at least one communication protocol of the network 108.

Generally, external computing system(s) 106 may be associated with entities that create, store, maintain, and/or provide data that is operated upon by model data generator 120 to generate synthetic samples and/or labels. For example, external computing system(s) 106 may be computing systems of healthcare providers that submit claims with accompanying medical records. As another example, external computing system(s) 106 may include a computing system/device of a healthcare provider that submits claims to the computing system 102, and further include one or more servers that store/maintain electronic health records (EHR), electronic medical records (EMR), and/or other data/information that computing system 102 can remotely access. While not explicitly shown in FIG. 1, one, some, or all of the external computing system(s) 106 may have components (e.g., processor(s), memory, network interface, and possibly I/O component(s)) that are generally similar to computing system 102 or client device 104.

The model data generator 120 is generally configured to perform operations that generate synthetic samples for particular labels, after which the synthetic samples can be used by computing system 102 or another computing system to build (generate or update) one, some, or all of classification model(s) 138. As noted above and discussed in more detail below, the model data generator 120 generates synthetic samples using iterative techniques that can advantageously improve the classification/labeling performance of the resulting classification model(s) 138, e.g., by automatically synthesizing labeled samples that are both diverse and representative of real-world samples. Within model data generator 120, label generator 130 generally processes historical reviews (e.g., notes/reviews that indicate the appropriate labels for different record portions, and that were created by users similar to the user of client device 104) to determine a set of one or more candidate labels that the classification model(s) 138 is to use when classifying record portions. Also within the model data generator 120, synthetic sample generator 132 generally uses language model(s) 136 to generate respective sets of synthetic samples for the labels. Model data generator 120 may store the resulting sets of synthetic samples as model data 152 (e.g., one or more databases stored in memory 112 and/or other memories), and use the model data 152 to build the classification model(s) 138. Alternatively, a different component or different computing system may build the classification model(s) 138 using the sets of synthetic samples.

Labeling component 134 generally uses the resulting classification model(s) 138 to process new records (e.g., medical records from external computing system(s) 106) and to label portions of those new records. As used herein, the term “new record” (or “new record portion,” etc.) can broadly include any record (or record portion, etc.) that is to be labeled in full or in part (e.g., to be processed by labeling component 134 when using classification model(s) 138), and does not necessarily refer to a newly created or newly received record.

The language model(s) 136 may include any suitable type or types of language model (e.g., one or more LLMs and/or one or more small language models (SMLs)), each of which is configured to receive a text prompt (referred to herein at times as simply a “prompt”) as an input, process the text prompt, and output text responsive to the text prompt. In some embodiments, one or more of the language model(s) 136 are multimodal language models that operate upon text and also one or more other types of content applied as input (e.g., images, audio, etc.). One, some, or all of the language model(s) 136 may have transformer-based model architectures that comprise an encoder that tokenizes the input and determines embeddings for the tokens (i.e., converts the tokens to embeddings/vectors), and a decoder that generates the output text based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The language model(s) 136 may include one or more general-purpose models (e.g., model(s) trained on a wide array of publicly available datasets such as web pages, documents, etc., available via the Internet) such as a generative pre-trained transformer (GPT) or bi-directional encoder representations from transformers (BERT), or may be a domain-specific model (e.g., trained and/or fine-tuned on custom and/or proprietary datasets).

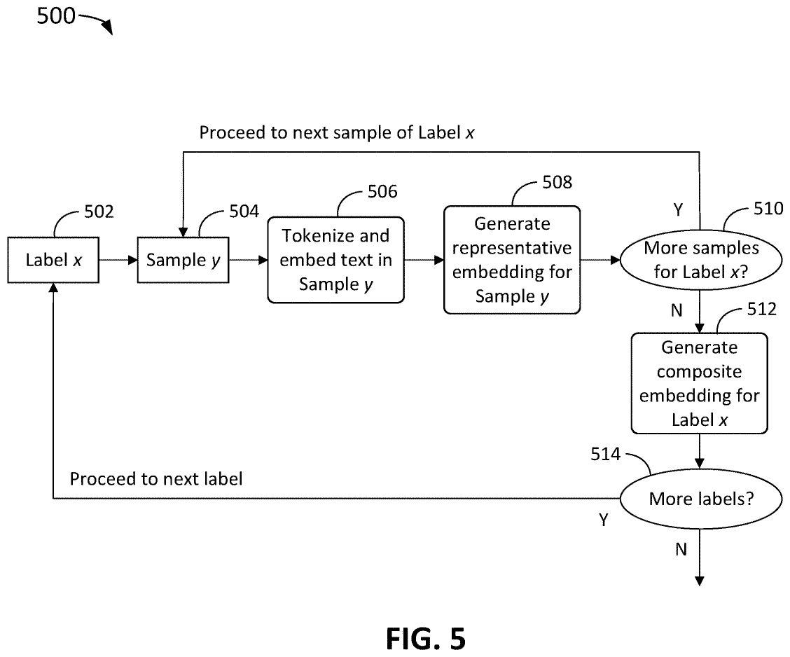

The classification model(s) 138 may include any suitable type or types of model that is/are built from supervised/labeled samples, and that is/are capable of outputting an indication of a particular class/label for a given text input. For example, the classification model(s) 138 may include a model that comprises a different embedding for each of a number of potential/candidate labels (e.g., with those embeddings being determined based on samples generated by synthetic sample generator 132, as discussed further below in connection with FIG. 5), may include a number of deep neural networks, support vector machines (SVMs), XGBoost models, and/or other classifier(s) (e.g., only one, or one per candidate label, etc.) that are trained using samples generated by synthetic sample generator 132, or may include a language model (e.g., similar to any of language model(s) 136) that is trained or tuned using samples generated by synthetic sample generator 132, etc.

The functionality/operation of model data generator 120 and labeling component 134 is discussed below in more detail, according to various embodiments.

### Example Model Generation Processes

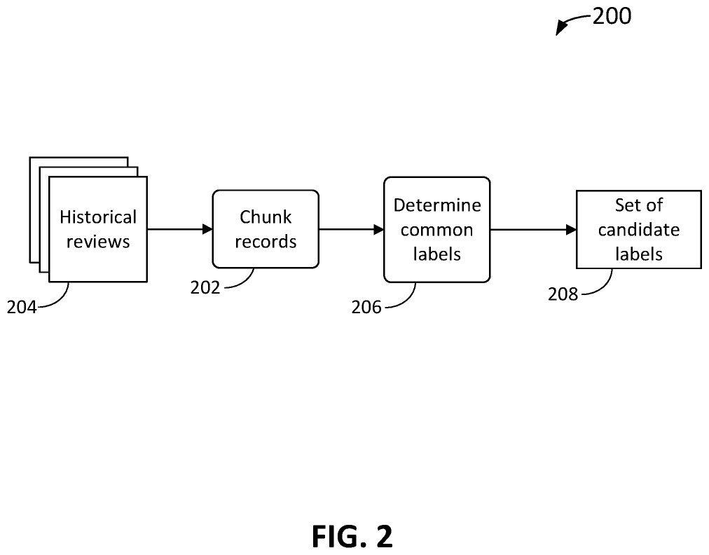

FIG. 2 depicts an example process 200 that may be implemented by the computing system 102 of FIG. 1 (e.g., by processor(s) 110 when executing the instructions of label generator 130) to generate one, some, or all of the candidate labels according to which classification model(s) 138 will be configured to classify portions of records (i.e., the labels that are to serve as candidates for labeling a given record portion). For ease of explanation, the process 200 is described with specific reference to elements of computing environment 100 of FIG. 1. In alternative embodiments, the candidate labels are determined using an automated or partially automated process that is different than the one shown in FIG. 2, or are manually entered by a user (in which case the label generator 130 may be omitted from the computing environment 100), etc.

In the example process 200, at a stage 202, the label generator 130 chunks (parses into segments) one or more historical reviews 204. The reviews/notes may be provided by external computing system(s) 106, for example. The historical reviews 204 may include, for example, text notes that were manually created by individuals (e.g., entered by expert clinical reviewers using respective computing devices similar to client device 104) and indicate labels that the individuals assigned to various different record portions. In some embodiments and/or scenarios, the historical reviews 204 do not include the actual record portions to which the individuals assigned those labels (e.g., historical reviews 204 may simply be lists of labels, etc.). The chunk/segment size (e.g., a fixed or maximum number of characters, tokens, pages, etc.) may be predetermined based on the context window size limit for a language model of language model(s) 136 (i.e., the language model discussed below in connection with stage 206), for example. In some embodiments and/or scenarios, a single chunk/segment includes multiple labels corresponding to multiple reviews/notes.

At stage 206, the label generator 130 analyzes the chunked/parsed historical reviews 204 to determine which labels were most frequently/commonly assigned in those reviews. In some embodiments, stage 206 includes, for each of one, some, or all of the resulting chunks/segments, prompting a language model (e.g., one of language model(s) 136) to determine which labels are commonly (or most commonly, etc.) identified as being indicated by the reviewer. In the example of a clinical reviewer for claim-related medical records, for example, the following prompt template may be used:
Analyze the following notes delimited by triple backticks made by a clinical reviewer when reviewing a facility medical record.
Each note of multiple notes, made by reviewers when reviewing different medical records, is delimited in the text by 5 asterisks (*****)
Answer the question at the end.
“‘{note 1}*****{note 2}****{note 3}[etc.]’”
QUESTION:
“What are the facility medical record sections most commonly identified as being of interest to the reviewer?”

More generally, the prompt template may include the reviews/notes (indicating the labels) created by the reviewers, and an instruction or query indicating that the language model is to identify commonly used labels across all reviews/notes included in the chunk/segment. In some embodiments, the prompt template also indicates the type(s) of delimiters used to separate the notes/reviews in the chunk/segment.

One example of an output/response generated by the language model is the following:
The common facility medical record sections identified as being of interest to the reviewer include:
1. Discharge Disposition (DC Dispo): This section indicates the place to which the patient was discharged, such as home, skilled nursing facility (SNF), home health care (HHC), inpatient rehabilitation, hospice, or expired.
2. Admit Order: This section contains information about the patient's admission status, such as inpatient, outpatient, or emergency department admission.
3. Principal Diagnosis (PDX): This section lists the primary diagnosis for which the patient was admitted and treated during their hospital stay.
4. Secondary Diagnosis (SDX): This section includes additional diagnoses that affect the Diagnosis-Related Group (DRG) and severity of illness (SOI). It may also include complications or comorbid conditions (CCs) and major comorbid conditions (MCCs).
5. Procedure: This section details any surgical or medical procedures performed during the hospital stay, including codes and descriptions.
6. Clinical Criteria—Sepsis 3: This section reviews the clinical criteria for sepsis, including systemic inflammatory response syndrome (SIRS), organ dysfunction scores, and the presence of septic shock.
7. Page Numbers: The reviewer often references specific page numbers where relevant information can be found, such as progress notes, discharge summaries, operative reports, and lab results.
8. Additional Notes: This section may include queries, comments, or additional clinical information that supports or refutes the coding and clinical validation of diagnoses and procedures.
9. Claim Audit Status: This indicates whether the claim was audited and if any changes were made as a result of the review.

The label generator 130 may repeat this prompting process for each of multiple chunks/segments (e.g., all chunks/segments) generated at stage 202. In such embodiments, the label generator 130 may again prompt the language model (or a different model of language model(s) 136) to determine which labels are common (or most common, etc.) across the outputs (label lists) for some or all of the iterations. For example, a prompt template for this subsequent prompting may be:
Analyze the following summaries, delimited by triple backticks, which each summarize the common sections of a facilities medical record/There
are 4 summaries, each delimited in the text by 5 asterisks (*****)
Answer the question at the end.
Respond in the following JSON format:

{{
″answer″: [String],
}}
‘‘‘{summary1}*****{summary 2}****{summary 3}[etc.]‘‘‘

QUESTION: “What are the common sections found across all the summaries?

More generally, this second prompt template may include the summaries (indicating the most common labels for the various chunks/segments), and an instruction or query indicating that the language model is to identify commonly used labels across all of the included summaries. In some embodiments, the prompt template also indicates the type(s) of delimiters used to separate the included summaries.

Other techniques may also or instead be used to automatically determine candidate labels. In some embodiments, for example, the label generator 130 analyzes the historical records themselves, instead of reviews/notes for the historical records. For example, the label generator 130 may generate the following prompt:
You are a medical coding expert. What are the common sections found in the following facility medical records?:
{medical records or link thereto}
   The medical records may be provided by external computing system(s) 106, for example. Such an approach could potentially lack the same level of reliability provided when using manually generated (e.g., expert-generated) reviews/notes, but can advantageously reduce the need for a large, trusted collection of such reviews/notes. Moreover, automatically generated candidate labels may still be reviewed by expert(s) to confirm their applicability/validity.

Regardless of the technique used, the output of process 200 is a set 208 of one or more candidate labels. The set 208 of candidate labels may comprise or consist of all labels determined at stage 206, or a subset of the labels determined at stage 206 (e.g., after filtering and/or validating the commonly used labels). In some embodiments, the set 208 of candidate labels also or instead includes one or more labels determined by other means (e.g., manually entered by a user).

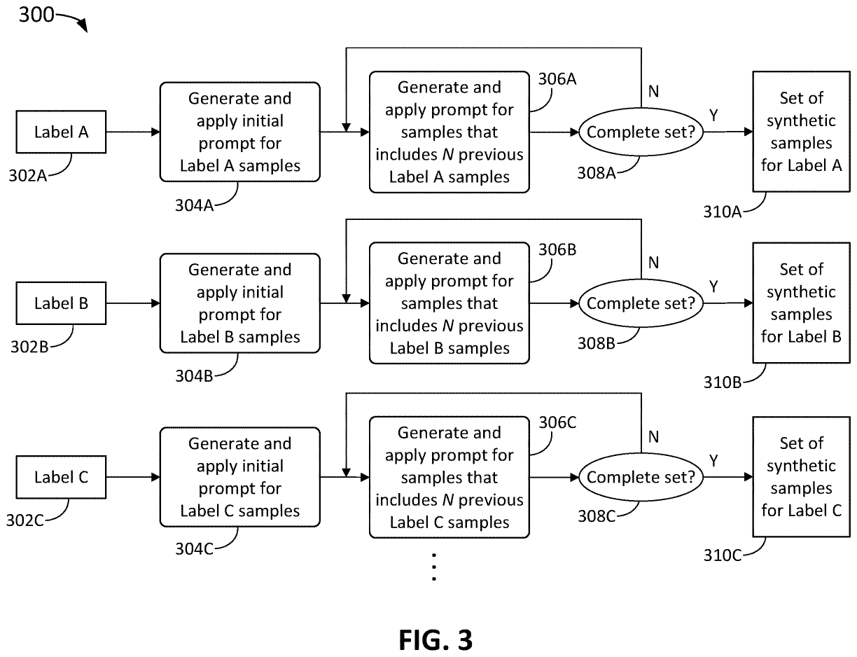

FIG. 3 depicts an example process 300 for generating synthetic samples for a set of labels (e.g., the set 208 of candidate labels generated by process 200), which may be implemented by the computing system 102 of FIG. 1, for example. FIG. 3 depicts an example embodiment and/or scenario in which there are at least three candidate labels 302A, 302B, and 302C, also referred to herein as “Label A”, “Label B”, and “Label C”, respectively. In other embodiments and/or scenarios, however, the process 300 applies to more or fewer candidate labels.

At stage 304A, the synthetic sample generator 132 generates an initial (earliest in time) prompt for creating one or more samples that correspond to (i.e., are correctly/properly labeled with) Label A, and applies the initial prompt to a language model of language model(s) 136. In embodiments that include the label generator 130, and in which the label generator 130 also uses a language model as discussed above, the synthetic sample generator 132 may (at stage 304A) use the same language model or a different language model as the label generator 130.

At stage 306A, the synthetic sample generator 132 generates a subsequent prompt for creating synthetic samples that correspond to (i.e., are correctly/properly labeled with) Label A, and applies the prompt to the language model. The prompt generated at stage 306A consists of or includes up to N previous samples that were generated (during process 300) for Label A, where N is any suitable integer greater than zero (e.g., 10, 100, 1000, etc.), and instructs the language model to make the new sample(s) diverse relative to (e.g., as distinct as possible from) those N previous samples. N may be limited by context window size limits, for example. In some embodiments, the prompt generated at stage 306A consists of or includes the N most recently generated synthetic samples for Label A (e.g., from one or more most recent iterations of the Label A portion of process 300). In early iterations, however, the prompt may include fewer than N samples (e.g., if fewer than N samples were to that point generated using process 300).

Each of some or all of the prompts at stages 304A and 306A may instruct the language model to generate a particular number of samples corresponding to Label A (e.g., one sample, or 10 samples, etc.). Moreover, the prompts may instruct the language model to generate samples that generally reflect real-world samples (e.g., historical record sections). As one example, the synthetic sample generator 132 may use the following template for the initial prompt at stage 304A as well as subsequent prompt(s) at iteration(s) of stage 306A:
Generate a sample {label} section of a facility medical record. Try to make it as realistic as possible including the use of proper names for people and facilities.
Below are some sample sections already generated, delimited by <<<PAGE NUMBER>>>:
{samples_previously_generated}
When generating the new sample section text try to keep it as distinct as possible from those that have been previously generated, including the various formats of records that would be expected to be found (e.g., some with different sections than others), but ensure the new sample section is reflective of a real-world {label} section.
In your answer return just the text for the new sample section and nothing else.

For the initial prompt at stage 306A, the synthetic sample generator 132 may leave the {samples_previously_generated} portion empty (a null set) due to the absence of previous samples in the first iteration. Alternatively, the synthetic sample generator 132 may, for the initial prompt, use a different template that omits any reference to previously generated samples. In embodiments where each prompt instructs the language model to generate more than one sample, the prompt may also instruct the language model to make the samples diverse (e.g., “as distinct as possible”) from each other.

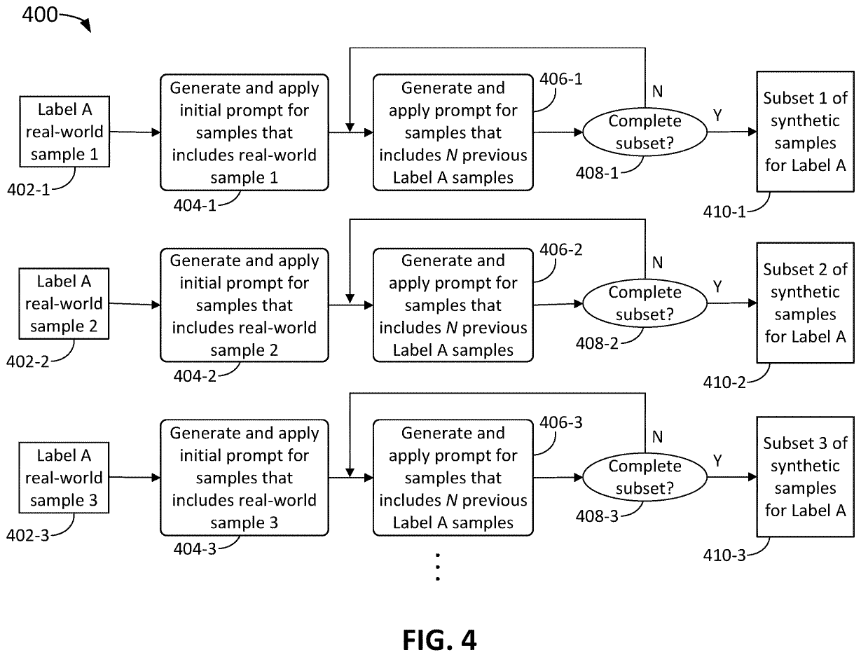

More generally, the prompt template may include the name of the label for which the samples are being generated (i.e., Label A), such as “History & Physical”, “Clinical Criteria”, etc.), an instruction to make the sample(s) realistic and/or reflective of real-world samples, an instruction to make the new sample(s) diverse (e.g., “as distinct as possible”) from any samples populating the {samples_previously_generated} portion, and possibly other instructions (e.g., an instruction use proper names for people and facilities as in the example above). In some embodiments, one or more of the prompts (e.g., just the initial prompt) include one or more real-world samples to enable the language model to generate synthetic samples that are generally more reflective of real-world samples, despite being distinct from the specifics of any included real-world sample(s). Such embodiments are discussed in more detail below in connection with FIG. 4.

At stage 308A, the synthetic sample generator 132 determines whether a complete set of synthetic samples has been generated for Label A. If so, the samples generated for Label A to that point by the synthetic sample generator 132 form a complete set 310A. If not, the synthetic sample generator 132 performs a next iteration of stage 306A to generate additional synthetic samples, with the loop continuing as shown in FIG. 3 until the synthetic sample generator 132 determines that the set is complete at a future iteration of stage 308A. In some embodiments, the synthetic sample generator 132 determines that the set is complete at stage 308A in response to determining that the set includes at least a predetermined number of synthetic samples (e.g., 1000, 10,000, etc.). In other embodiments, the synthetic sample generator 132 uses one or more other techniques to determine completion. For example, the synthetic sample generator 132 may generate an embedding for each of some or all samples generated for Label A (and possibly also for any real-world seed samples), compute a similarity metric indicative of the level of diversity among the full set of samples (e.g., a standard deviation of cosine similarity distances between embeddings), and determine whether the set is complete based on the similarity metric (e.g., determine the set is complete if and only if the standard deviation or other metric exceeds or otherwise satisfies a predetermined threshold).

Stages 304B and 304C may be similar to stage 304A, stages 306B and 306C may be similar to stage 306A, and stages 308B and 308C may be similar to stage 308A. The synthetic sample generator 132 may pair the resulting sets 310A, 310B, 310C of synthetic samples with their respective labels 302A, 302B, 302C (i.e., Labels A, B, C) to form labeled data for use in building (generating or updating) at least one model of classification model(s) 138. One example of how the synthesized samples may be used to build a classification model is discussed below in connection with FIG. 5.

FIG. 4 depicts an example process 400 for generating synthetic samples for a single label (e.g., “Label A” designated as label 302A in FIG. 3) using real-world samples as seed samples. The process 400 may be implemented by the computing system 102 of FIG. 1, for example. In some embodiments, the synthetic sample generator 132 performs the process 400 once for each label of the set 208 of candidate labels (e.g., for labels 302A, 302B, 302C, etc. in FIG. 3).

In FIG. 4, real-world samples 402-1, 402-2, and 402-3 are known to correspond to Label A. In other embodiments and/or scenarios, the process 400 may instead operate on fewer real-world samples (e.g., one or two) or more real-world samples (e.g., 10, 100, etc.). Stages 404-1 through 404-3 may each be similar to stage 304A, stages 406-1 through 406-3 may each be similar to stage 306A, and stages 408-1 through 408-3 may each be similar to stage 308A. In the depicted embodiment, however, at least the initial prompts generated at stages 404-1, 404-2, 404-3 include a respective real-world sample (e.g., an actual medical record section known to correspond to Label A) as a seed sample. In other embodiments, each of one, some, or all of the initial prompts include multiple real-world samples as seed samples.

For example, in the example prompt template discussed above in connection with FIG. 3, the synthetic sample generator 132 may generate the initial prompt at stage 404-1 by populating the {samples_previously_generated} portion with the real-world sample 402-1, rather than using previously generated synthetic samples (as such samples may not yet exist). Advantageously, this can help ensure that the initial synthetic sample(s) (and, by extension, the sample(s) generated in later iteration(s)) are generally more representative of real-world samples (e.g., less likely to reflect hallucinations by the language model, etc), even in embodiments where the initial prompt instructs that the new samples be made diverse from (e.g., have different details/specifics than) the real-world sample(s). The synthetic sample generator 132 may extract some or all of the real-world samples 402-1, 402-2, 402-3 from various records (e.g., by extracting specific sections from medical records provided, maintained, etc., by one or more of external computing systems(s) 106). For each real-world seed sample 402-1, 402-2, 402-3, the corresponding part of process 400 produces a respective subset 410-1, 410-2, 410-3 of the samples for Label A (e.g., a respective subset of the sample set 310A). That is, the synthetic sample generator 132 may aggregate the subsets 410-1, 410-2, 410-3 (and any other such subsets) to form the complete sample set for Label A. In some embodiments, the synthetic sample generator 132 also adds real-world samples to the sample set for Label A, such as the seed samples 402-1, 402-2, 402-3 and possibly other real-world samples.

FIG. 5 depicts an example process 500 for generating or updating at least one classification model (e.g., one or more of classification model(s) 138), which may be implemented by the computing system 102 of FIG. 1, for example. The computing system 102 or another computing system may perform the process 500 once for each label of a set of candidate labels (e.g., set 208), or for only some labels of the set of candidate labels. For ease of explanation, FIG. 5 is described with reference to an embodiment in which the computing system 102 performs the process 500.

For a given (x-th) label 502, the computing system 102 tokenizes, and embeds (generates embeddings/vectors for) the tokens (e.g., words) of, a y-th sample 504 at stage 506. The sample 504 is a sample corresponding to the particular label 502 under consideration. For example, the sample 504 may be a synthesized sample generated by synthetic sample generator 132 using process 300 or process 400, or a real-world “seed” sample, etc. At stage 508, the computing system 102 generates a representative embedding for the sample 504. Stage 508 may include operating on some or all of the token embeddings generated at stage 506 to derive a new embedding. For example, stage 508 may include generating an embedding that is an average or mean of some or all of the embeddings generated at stage 506.

At stage 510, the computing system 102 determines whether any more samples are present for the label 502. If so, the process 500 iterates/repeats for the next sample in the set of samples as shown in FIG. 5. If not, then computing system 102 generates a composite embedding for the label 502 at stage 512. For example, stage 512 may include generating an embedding that is an average or mean of some or all of the representative embeddings generated across the iterations of stage 508.

At stage 514, the computing system 102 determines whether any more labels are present within the set of candidate labels. If so, the process 500 iterates/repeats for the next label in the set of labels as shown in FIG. 5. If not, then computing system 102 may terminate, and the resulting composite embeddings for the various labels may be stored (e.g., in model data 152) as a part of (or for use by) a classification model of classification model(s) 138. For example, one composite embedding may correspond to a “Discharge Disposition” label, another composite embedding may correspond to a “Clinical Criteria” label, and so on.

In other embodiments, other processes may be used to generate or update classification model(s). For example, the computing system 102 may store the full set of representative embeddings (generated at stage 508) in association with a particular label, without generating a composite embedding at stage 512. As another example, if the classification model(s) 138 include a classifier such as a neural network, SVM, XGBoost model, etc., the computing system 102 may use the labeled samples as training data for the classifier (which can potentially include generating embeddings of the samples at an embedding layer of the classifier, but not necessarily generating representative or composite embeddings, etc.).

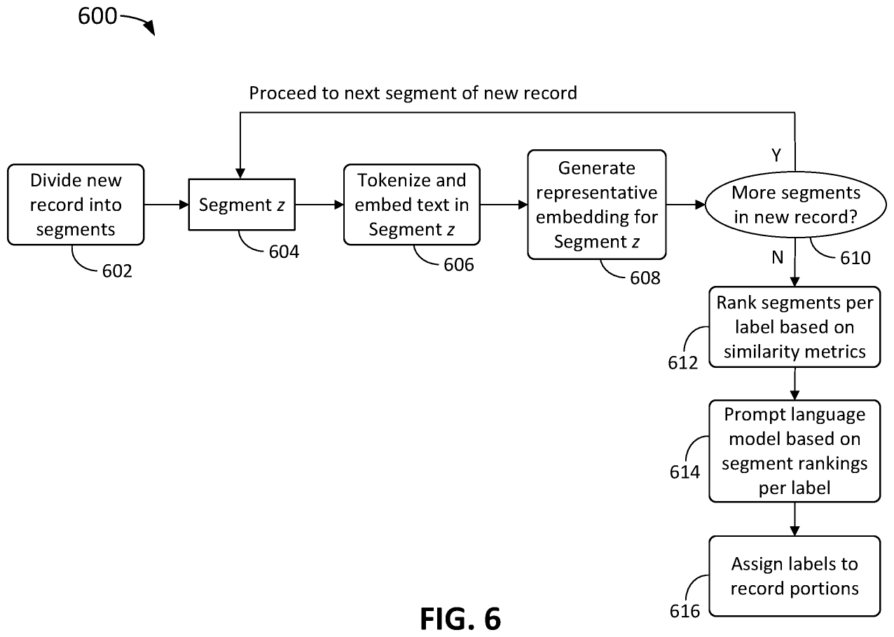

FIG. 6 depicts an example process 600 for using a classification model (e.g., of classification model(s) 138) to label portions of a new record. The process 600 may be implemented by the computing system 102 of FIG. 1, for example. It is understood that classification model(s) built using synthesized samples may instead operate in other ways. The process 600 is just one example that may correspond, for instance, to an embodiment in which the classification model is built using the process 500 of FIG. 5. For ease of explanation, FIG. 6 is described with reference to an embodiment in which the labeling component 134 performs the process 600, and in which the process 600 is performed using a single classification model 138. It is understood, however, that as used herein the term “model” may refer to a model that comprises multiple component models.

At stage 602 of process 600, the labeling component 134 divides a new record into segments. For example, each segment may be a page of the new record, or an otherwise delimited portion of the new record. For a given (z-th) segment 604, the labeling component 134 tokenizes, and embeds (generates embeddings/vectors for) the tokens (e.g., words) of, the segment 604, at stage 606. At stage 608, the labeling component 134 generates a representative embedding for the segment 604. Stage 608 may include operating on some or all of the token embeddings generated at stage 606 to derive a new embedding. For example, stage 608 may include generating an embedding that is an average or mean of some or all of the embeddings generated at stage 606.

At stage 610, the labeling component 134 determines whether any more segments are present for the new record. If so, the process 600 iterates/repeats for the next segment in the new record as shown in FIG. 6. If not, then labeling component 134 calculates similarity metrics for each of one, some, or all of the segments (e.g., pages), and ranks the segments on a per-label basis according to their similarity metrics, at stage 612. The labeling component 134 may calculate cosine similarity metrics, for example. Stage 612 may retain, for use in subsequent stage(s), only the M highest-ranked segments for each of the set of candidate labels, where M is an integer greater than one.

At stage 614, based at least in part on the segment rankings per label, the labeling component 134 prompts a language model (e.g., one of language model(s) 136) to determine the correct segments for a given label. An example prompt template that the labeling component 134 may use at stage 614 for each of some or all labels may be:
Below is a set of medical record pages from a facility medical record that are related to the section: {label}
Each page is identified by a page number in the following format: <<<PAGE followed by the page number and then>>.
Analyze each of the pages and answer the question at the end.
“‘{new_record_page_text}’”
QUESTION:
Which of these pages is the correct {label} page, as opposed to one that merely resembles the correct pages and/or merely makes reference to the correct page. It is ok to have either zero pages found or more than one page found. If more than one page is found respond with the answer in ascending order of the page number.
Respond with the page number(s) only. If no pages are found respond with −1.
   The labeling component 134 may then assign, at stage 616, the label to the pages indicated in the output of the language model. Stage 616 may include making such an assignment for each of one, some, or all labels in the set of candidate labels. Assigning a label to a page or set of pages may include generating or updating one or more data structures (e.g., stored in memory 112) indicating the association between label(s) and page(s), for example.

In other embodiments, the labeling component 134 uses other techniques to assign labels to segments of the new record. For example, for a given segment, the labeling component 134 may assign the segment to the label for which that segment has the highest similarity metric, without prompting a language model.

In another approach (or, in some embodiments, an approach used in conjunction with any techniques disclosed elsewhere herein, to further increase the amount of data for building the classification model(s) 138, etc.), the model data generator 120 generates labeled samples based on real-world reviews, without necessarily synthesizing samples. In one such embodiment, the model data generator 120 processes real-world reviews (e.g., clinical reviewer notes) to derive a labeled set of record portions (e.g., medical record pages).

For example, a clinical reviewer note may be:
BCNS DS PG 10 hydronephrosis H&P PG 15 sepsis, consult PG 29 sepsis—UTI PN PG 72 CD Dispo: Admit Order: not found PDX: sepsis SDX: UTI Procedure: Clinical Criteria—Sepsis 3 Page Number(s) Initial Bolus Start Time and Date: additional 1 L going Initial Bolus Stop Time and Date: 29 PaO2/FiO2: Platelets: Total Bilirubin: MAP or Vasopressor: 60 s, 67,61,66,62 PG 22,228,231,232 GCS: Creatinine: 2.70,2.65 baseline is 1.74 PG 19,26,11 Claim audited No-Change
   As seen in this hypothetical example, the labels/sections Discharge Summary (“DS”), History & Physical (“H&P”), and Consultations (“consult”) are identified by the clinical reviewer in the note. For each note such as the example above, the model data generator 120 may prompt a language model of language model(s) 136 to extract each section of interest that the language model can detect within the note, and output/indicate the extracted label/section together with the relevant page number(s) identified by the reviewer. The model data generator 120 may instruct the language model to only return those labels/sections that are present in the note, and to return a placeholder (e.g., “−1”) for any label/section not present in the note. The output of the language model may be a mapping from label/section to page number for all labels/sections of interest.

In such an aspect/embodiment, the model data generator 120 may then extract the relevant page(s) of the medical record as indicated in the language model output, and prompt the language model a second time. The second prompt may include extracted page text and a corresponding label, and instruct the language model to confirm whether the extracted page(s) is/are genuine example(s) of the label/section of interest. The model data generator 120 may repeat variations of the second prompt for all extracted pages and/or all labels/sections of interest, for example. The resulting set of (properly formatted) samples may then be used (e.g., by computing system 102) to generate or update one or more of the classification model(s) 138.

### Example Computer-Implemented Method

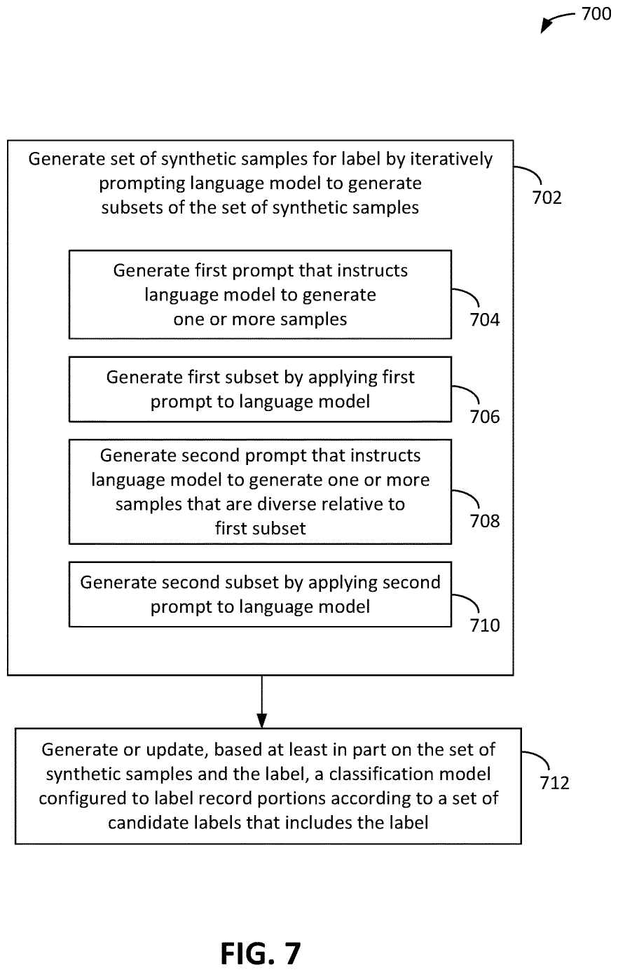

FIG. 7 depicts a flow diagram of an example computer-implemented method 700 for facilitating accurate labeling of record portions. For ease of explanation, the method 700 is described with reference to an embodiment in which the method 700 is performed by processor-executable instructions of model data generator 120 (and possibly also labeling component 134) when executed by processor(s) 110. In other embodiments, however, the method 700 is performed by other application(s) and/or another computing system.

At block 702 of the method 700, the model data generator 120 generates a set of synthetic samples for a label (e.g., for one label of the set 208) by iteratively prompting a language model (e.g., one of language model(s) 136) to generate subsets of the set of synthetic samples. Block 702 includes blocks 704, 706, 708, and 710. At block 704, the model data generator 120 generates a first prompt that instructs the language model to generate one or more samples. The first prompt may be the initial prompt overall, or a later prompt. At block 706, the model data generator 120 generates a first subset (i.e., one or more samples) of the set of synthetic samples by applying the first prompt to the language model. At block 708, the model data generator 120 generates a subsequent, second prompt that instructs the language model to generate one or more samples that are diverse relative to the first subset generated at block 706. At block 710, the model data generator 120 generates a second subset of the set of synthetic samples by applying the second prompt to the language model. Blocks 704 and 706 may collectively be similar to stage 304A or 404-1 and blocks 708 and 710 may collectively be similar to stage 306A or 406-1, for example. Block 702 may also include one or more additional pairs of blocks, similar to the pair of blocks 708, 710, in which additional prompts are generated and used to generate additional subsets of the set of synthesized samples.

At block 712, the model data generator 120 generates or updates, based at least in part on the set of synthetic samples (and possibly other samples, such as real-world samples used as “seed” samples) and the label, a classification model that is configured to classify/label record portions according to a set of candidate labels that includes the label. In embodiments and/or scenarios where the set of candidate labels includes two or more labels, the model data generator 120 may repeat block 702 for each of one, some, or all of the additional labels. Block 712 may include generating embeddings that the classification model uses to label new record portions, and/or training (e.g., initially training, refining, tuning, etc.) a classifier (e.g., neural network, SVM, XGBoost model, etc.), or any other suitable technique (e.g., as discussed above in connection with FIG. 5).

In other embodiments, the method 700 may include additional blocks not shown in FIG. 7. For example, the method 700 may include an additional block, occurring after block 712, in which one or more portions of a new record are labeled (e.g., by labeling component 134) using the classification model.

### EXAMPLES

Example 1. A computer-implemented method for facilitating accurate labeling of record portions, the computer-implemented method comprising: generating, by one or more processors, a set of synthetic samples for a label by iteratively prompting a language model to generate subsets of the set of synthetic samples, wherein iteratively prompting the language model comprises: generating a first prompt that instructs the language model to generate one or more samples; generating at least a first subset of the set of synthetic samples by applying the first prompt to the language model; generating a second prompt that instructs the language model to generate one or more additional samples that are diverse relative to the first subset of the set of synthetic samples; and generating a second subset of the set of synthetic samples by applying the second prompt to the language model; and generating or updating, by the one or more processors and based at least in part on the set of synthetic samples and the label, a classification model that is configured to label record portions according to a set of candidate labels that includes the label.

Example 2. The computer-implemented method of example 1, wherein generating the second prompt includes generating the second prompt to include no more than N most recently generated synthetic samples, N being an integer greater than one.

Example 3. The computer-implemented method of example 1 or 2, wherein generating the first prompt comprises instructing the language model to generate samples that are diverse relative to one or more real-world samples.

Example 4. The computer-implemented method of any one of examples 1-3, further comprising: generating, by the one or more processors and based at least in part on historical reviews, a set of labels that includes the label.

Example 5. The computer-implemented method of example 4, wherein generating the set of labels includes using the language model, or a different language model, to determine commonly used labels from the historical reviews.

Example 6. The computer-implemented method of any one of examples 1-5, wherein generating or updating the classification model comprises generating respective embeddings for a plurality of sample sets corresponding to different labels of the set of candidate labels.

Example 7. The computer-implemented method of example 6, further comprising: labeling, by the one or more processors, one or more portions of a new record using the classification model, at least in part by: generating respective embeddings for a plurality of segments of the new record; and labeling the one or more portions of the new record based at least in part on (i) the respective embeddings for the plurality of sample sets corresponding to the different labels and (ii) the respective embeddings for the plurality of segments of the new record.

Example 8. The computer-implemented method of example 7, wherein labeling the one or more portions of the new record comprises: calculating similarity metrics for the label based at least in part on (i) the respective embeddings for a first sample set corresponding to the label and (ii) the respective embeddings for the plurality of segments of the new record; selecting one or more segments of the plurality of segments based at least in part on the similarity metrics for the label; generating a third prompt that includes the one or more segments of the plurality of segments; and verifying, by prompting the language model or a different language model with the third prompt, whether each of the one or more segments corresponds to the label.

Example 9. The computer-implemented method of any one of examples 6-8, wherein: generating the respective embeddings for the plurality of sample sets corresponding to the different labels comprises generating a composite embedding for a sample set corresponding to the label, at least in part by: converting a first sample of the sample set to a first set of token embeddings; generating a first representative embedding based at least in part on the first set of token embeddings; converting a second sample of the sample set to a second set of token embeddings; generating a second representative embedding based at least in part on the second set of token embeddings; and generating the composite embedding for the sample set based at least in part on the first representative embedding and the second representative embedding.

Example 10. The computer-implemented method of any one of examples 1-9, wherein the classification model is a machine-learned model, and wherein generating or updating the classification model comprises training the machine-learned model using the set of synthetic samples paired with the label.

Example 11. A system comprising: one or more processors; and one or more memories storing processor-executable instructions that, when executed by the one or more processors, cause the one or more processors to perform operations comprising the computer-implemented method of any one of examples 1-10.

Example 12. One or more non-transitory, computer-readable media storing processor-executable instructions that, when executed by one or more processors, cause the one or more processors to perform operations comprising the computer-implemented method of any one of examples 1-10.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., enreviewer-only model(s), enreviewer-dereviewer model(s), dereviewer-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method for facilitating accurate labeling of record portions, the computer-implemented method comprising:
generating, by one or more processors, a set of synthetic samples for a label by iteratively prompting a language model to generate subsets of the set of synthetic samples, wherein iteratively prompting the language model comprises:
generating a first prompt that instructs the language model to generate one or more samples;
generating at least a first subset of the set of synthetic samples by applying the first prompt to the language model;
generating a second prompt that instructs the language model to generate one or more additional samples that are diverse relative to the first subset of the set of synthetic samples; and
generating a second subset of the set of synthetic samples by applying the second prompt to the language model; and
generating or updating, by the one or more processors and based at least in part on the set of synthetic samples and the label, a classification model that is configured to label record portions according to a set of candidate labels that includes the label.

2. The computer-implemented method of claim 1, wherein generating the second prompt includes generating the second prompt to include no more than N most recently generated synthetic samples, N being an integer greater than one.

3. The computer-implemented method of claim 1, wherein generating the first prompt comprises instructing the language model to generate samples that are diverse relative to one or more real-world samples.

4. The computer-implemented method of claim 1, further comprising:
generating, by the one or more processors and based at least in part on historical reviews, a set of labels that includes the label.

5. The computer-implemented method of claim 4, wherein generating the set of labels includes using the language model, or a different language model, to determine commonly used labels from the historical reviews.

6. The computer-implemented method of claim 1, wherein generating or updating the classification model comprises generating respective embeddings for a plurality of sample sets corresponding to different labels of the set of candidate labels.

7. The computer-implemented method of claim 6, further comprising:
labeling, by the one or more processors, one or more portions of a new record using the classification model, at least in part by:
generating respective embeddings for a plurality of segments of the new record; and
labeling the one or more portions of the new record based at least in part on (i) the respective embeddings for the plurality of sample sets corresponding to the different labels and (ii) the respective embeddings for the plurality of segments of the new record.

8. The computer-implemented method of claim 7, wherein labeling the one or more portions of the new record comprises:
calculating similarity metrics for the label based at least in part on (i) the respective embeddings for a first sample set corresponding to the label and (ii) the respective embeddings for the plurality of segments of the new record;
selecting one or more segments of the plurality of segments based at least in part on the similarity metrics for the label;
generating a third prompt that includes the one or more segments of the plurality of segments; and
verifying, by prompting the language model or a different language model with the third prompt, whether each of the one or more segments corresponds to the label.

9. The computer-implemented method of claim 6, wherein:
generating the respective embeddings for the plurality of sample sets corresponding to the different labels comprises generating a composite embedding for a sample set corresponding to the label, at least in part by:
converting a first sample of the sample set to a first set of token embeddings;
generating a first representative embedding based at least in part on the first set of token embeddings;
converting a second sample of the sample set to a second set of token embeddings;
generating a second representative embedding based at least in part on the second set of token embeddings; and
generating the composite embedding for the sample set based at least in part on the first representative embedding and the second representative embedding.

10. The computer-implemented method of claim 1, wherein the classification model is a machine-learned model, and wherein generating or updating the classification model comprises training the machine-learned model using the set of synthetic samples paired with the label.

11. A system comprising:
one or more processors; and
one or more memories storing processor-executable instructions that, when executed by the one or more processors, cause the one or more processors to perform operations comprising:
generating a set of synthetic samples for a label by iteratively prompting a language model to generate subsets of the set of synthetic samples, wherein iteratively prompting the language model comprises:
generating a first prompt that instructs the language model to generate one or more samples;
generating at least a first subset of the set of synthetic samples by applying the first prompt to the language model;
generating a second prompt that instructs the language model to generate one or more additional samples that are diverse relative to the first subset of the set of synthetic samples; and
generating a second subset of the set of synthetic samples by applying the second prompt to the language model; and
generating or updating, based at least in part on the set of synthetic samples and the label, a classification model that is configured to label record portions according to a set of candidate labels that includes the label.

12. The system of claim 11, wherein generating the second prompt includes generating the second prompt to include no more than N most recently generated synthetic samples, N being an integer greater than one.

13. The system of claim 11, wherein generating the first prompt comprises instructing the language model to generate samples that are diverse relative to one or more real-world samples.

14. The system of claim 11, wherein the operations further comprise:
generating, based at least in part on historical reviews, a set of labels that includes the label.

15. The system of claim 14, wherein generating the set of labels includes using the language model, or a different language model, to determine commonly used labels from the historical reviews.

16. The system of claim 11, wherein generating or updating the classification model comprises generating respective embeddings for a plurality of sample sets corresponding to different labels of the set of candidate labels.

17. The system of claim 16, wherein the operations further comprise:
labeling one or more portions of a new record using the classification model, at least in part by:
generating respective embeddings for a plurality of segments of the new record; and
labeling the one or more portions of the new record based at least in part on (i) the respective embeddings for the plurality of sample sets corresponding to the different labels and (ii) the respective embeddings for the plurality of segments of the new record.

18. One or more non-transitory, computer-readable media storing processor-executable instructions that, when executed by one or more processors, cause the one or more processors to perform operations comprising:
generating a set of synthetic samples for a label by iteratively prompting a language model to generate subsets of the set of synthetic samples, wherein iteratively prompting the language model comprises:
generating a first prompt that instructs the language model to generate one or more samples;
generating at least a first subset of the set of synthetic samples by applying the first prompt to the language model;
generating a second prompt that instructs the language model to generate one or more additional samples that are diverse relative to the first subset of the set of synthetic samples; and
generating a second subset of the set of synthetic samples by applying the second prompt to the language model; and
generating or updating, based at least in part on the set of synthetic samples and the label, a classification model that is configured to label record portions according to a set of candidate labels that includes the label.

19. The one or more non-transitory, computer-readable media of claim 18, wherein generating the second prompt includes generating the second prompt to include no more than N most recently generated synthetic samples, N being an integer greater than one.

20. The one or more non-transitory, computer-readable media of claim 18, wherein generating the first prompt comprises instructing the language model to generate samples that are diverse relative to one or more real-world samples.
